(19) United States
(12) Patent Application Publication
(10) Pub. No.: US 2025/0163969 A1
(43) Pub. Date: May 22, 2025

(54) Transmission Device

(71) Applicant: EJOT SE & CO. KG, Bad Berleburg (DE)

(72) Inventors: Jan STOETZER, Erfurt (DE); Daniel SPINDLER, Friedrichroda (DE)

(21) Appl. No.: 18/837,072

(22) PCT Filed: Feb. 10, 2023
(86) PCT No.: PCT/EP2023/053338

§ 371 Date: Aug. 8, 2024

(30) Foreign Application Priority Data
Feb. 10, 2022 (DE) 10 2022 103 191.8

(51) Int. Cl. F16D 1/116; F16D 1/10

(52) U.S. Cl. CPC F16D 1/116; F16D 2001/103

(57) ABSTRACT

A transmission device comprises an output element and a drive element comprising a drive body made from a first material, from a plastic. The drive body comprises a drive region and a connecting region. The output element engages into the connecting region that comprises positively locking structures which transmit a torque to the output element, the connecting region is configured such that the positively locking structures are radially movable, resulting that the output element is rotatable relative to the drive body with widening of the connecting region. The drive element comprises a compression element which preloads the drive body inwards in the radial direction in the connecting region, wherein the compression element is formed from a second material different from the first material and is elastic in the region of the widening portion and has a higher spring stiffness than the connecting region of the drive body.

The invention relates to a transmission device for transmitting rotary motion.

In a large number of applications, it is necessary to adjust or readjust a system or assembly in due course using a transmission of rotary motion with minimum torque.

In order to protect the system, it should not be possible to transmit excessive torque from the adjusting element to the system to be adjusted.

DE 20 2010 011 852 U1, for example, discloses a device which transmits rotary motion from a drive shaft to an adjusting screw via an adapter. The motion is transmitted via a ball joint member, which is made of plastic and has spring tabs that spring open once an overload torque has been reached, thus preventing the transmission of torque that is greater than the overload torque.

Depending on the field of application of the transmission device, the range between the required minimum torque and the permitted maximum torque may be very limited. Moreover, the period of use during which readjustment is possible can be very long, and it must be possible to guarantee use over several thousand hours, for example.

It is the object of the invention to provide a transmission device of this type which is easy to manufacture and which is capable of transmitting torque within narrow limits over a long period of time.

This object is accomplished by a transmission device that comprises an output element and a drive element, which drive element comprises a drive body made from a first material, in particular from a viscoelastic plastic material, in particular from a thermoplastic material. The drive body has a drive region and a connecting region, wherein the output element engages into the connecting region. The connecting region has inward-facing positively locking structures which are designed to transmit a torque to the output element. This allows a torque to be transmitted between the drive element and the output element in the manner of a toothed or splined shaft.

The connecting region is designed in such a way that its positively locking structures are radially movable in such a way that the output element is rotatable relative to the drive body while elastically widening the connecting region. As a result, when the maximum permissible torque is reached, the drive body can be rotated in relation to the output element, resulting in over-latching. Obviously, within the scope of the invention, the drive element and output element of the transmission device according to the invention can also be operated in the opposite direction.

The drive element furthermore comprises a compression element which is made from a second material that is different from the first material. The compression element preloads the drive body inwards in the radial direction in the connecting region, with the compression element being elastic in the region of the widening portion, i.e. in its load direction. The spring stiffness of the compression element in the load direction is higher than the spring stiffness of the drive body.

Furthermore, the second material of the compression element is selected such that its stress-strain curve, which is preferably linear in the working range, will change less under the influence of temperature and/or time than that of the first material of the drive body.

The elastic properties of the compression element can compensate for the decreasing elastic behavior of the in particular linear viscoelastic material to such an extent that a relatively narrow range of the torque to be transmitted is set for a long service life.

As a result, the drive body can be easily manufactured from a thermoplastic material in a primary shaping process and can be easily supplemented with a compression element, which is selected to meet the preload requirements with regard to the torque range to be transmitted, the expected temperature effects and the service life.

This design allows a narrow torque range to be set and a space-saving design to still be implemented, because the drive element essentially consists of just one single-piece base body.

The preferred first material is a linear viscoelastic material such as polyoxymethylene (POM). While such a material is well suited for a form-fitting torque transmission, its creep behavior prevents it from maintaining its preload sufficiently stable over a long service life for some applications. For the second material of the compression element, the transmission properties for transmitting the torque do not have to be taken into account, but the second material can generally be selected based on its properties with regard to its creep behavior. In addition to metallic materials, rubber materials can thus also be used for the compression element. In particular, a consistent modulus of elasticity with a linear elastic material behavior, which is largely unchanging over a long period of time, should be used.

In a preferred embodiment of the invention, the connecting region and the drive region are arranged in succession in an axial direction. This makes it possible to achieve a slim design with a single-piece drive body. The connecting region has at least two essentially hollow cylindrical tab portions that are resiliently connected to the drive region. The tab portions each have at least one positive locking structure for transmitting rotary motion to the output element.

In particular, the drive body has a cylindrical basic shape and has a groove on its outer surface in the connecting region, in which an annular compression element is accommodated. The cylindrical basic shape makes for easy rotational mounting of the drive body, and allows a permanent preload of the connecting region to be created in a simple manner.

Preferably, the positively locking structures can be formed by at least one longitudinal groove-like indentation in the material of a tab portion. This allows axial compensation to be achieved to a certain extent while maintaining the same torque. The output element and the drive element engage with one another in the connecting region.

The meshing positively locking structures of the connecting region and of the output element are preferably in the form of a rounded square with slightly concave edges. This ensures smooth over-latching once the maximum transmittable torque has been exceeded. As a result, any wear caused by over-latching can be kept to a minimum.

In another advantageous embodiment of the invention, the compression element can be made of spring steel. A spring steel ring can exert a constant elastic effect on the drive body over a long service life.

In particular, the drive body has tool engagement features on its end face, especially an internal drive. This makes it possible to select a slim design.

In the drawings,

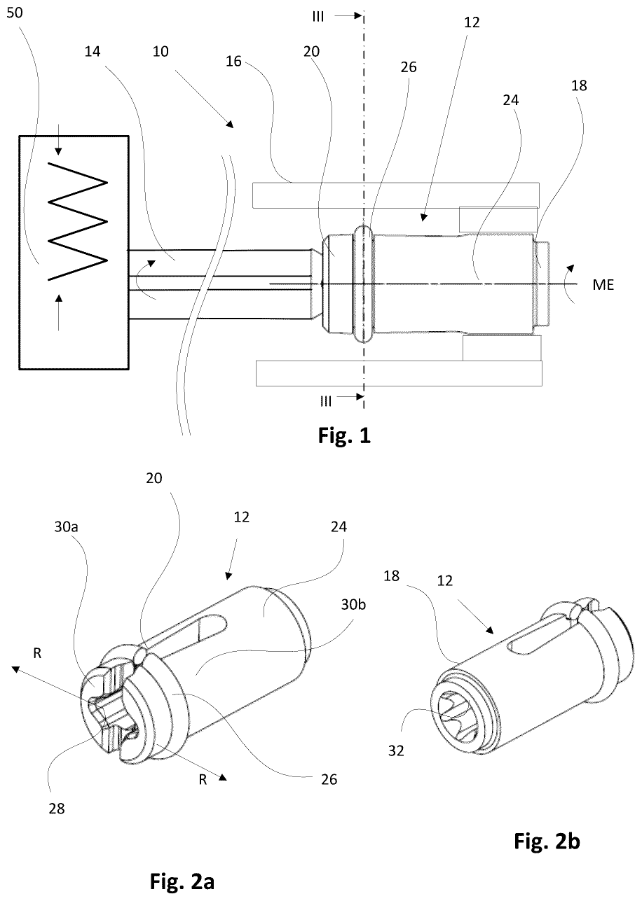

FIG. 1 is a schematic side view, in half-section, of a transmission device according to the invention;

FIG. 2a is a perspective view of the drive element according to the invention, with a view of the connecting region for connection to the output shaft;

FIG. 2b is a perspective view of the drive element according to the invention, with a view of the drive region;

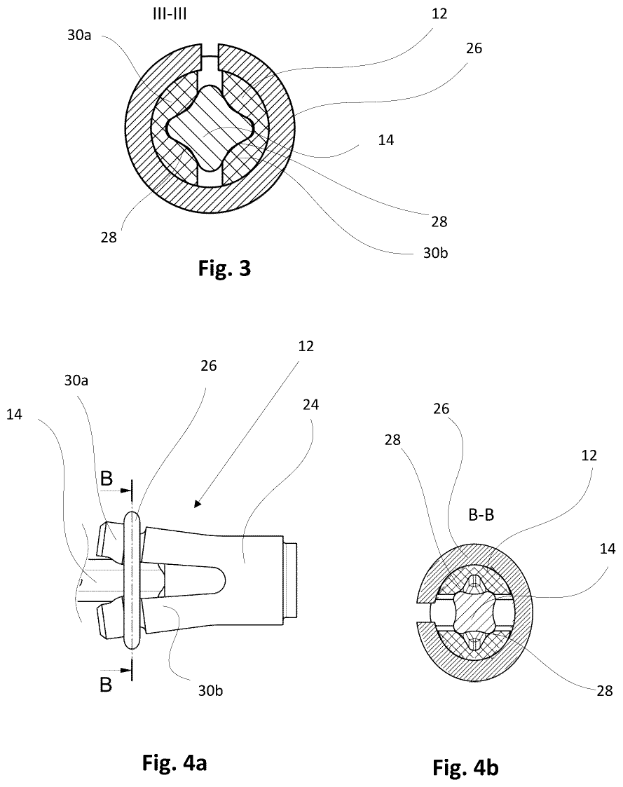

FIG. 3 is a view of a cross-section taken through the transmission device of FIG. 1, with the transmission device in a transmission position;

FIG. 4a is a side view of the transmission device, with the transmission device in an overload position, and

FIG. 4b is a view of a cross-section taken through the transmission device of FIG. 4a.

The view of FIG. 1 shows a transmission device 10 according to the invention, comprising a drive element 12 and an output element 14. The drive element 12 is rotatably mounted in a bearing 16.

The drive element 12 has a drive region 18 and a connecting region 20. The drive region 18 can be used to transmit a torque ME to the drive element 12. This torque is transmitted to an output element 14 connected to the drive element 12, which output element 14 is connected to an assembly 50. The assembly 50 can be adjusted by rotating the output element 14. For example, rotating the output element 14 could be used to set the preload of a spring. For this purpose, the transmission of a minimum torque may be necessary to achieve an increase in preload. Furthermore, the maximum transmittable torque may be limited to prevent the preload from exceeding a certain value. The assembly 50 is to be protected from the transmission of a torque in excess of a permissible torque M_{Z} to the mechanical components of the assembly.

For this purpose, the drive element 12 is designed as described with reference to FIGS. 2a and 2b, among others. The drive element 12 has a drive body 24 and a compression element 26. The drive body 24 is made from a viscoelastic plastic material, in particular from a thermoplastic material, in particular from POM, whereas the compression element 26 is made from a spring steel. The spring steel snap ring has a higher spring stiffness than the drive body in its connecting region. As a result, after widening, resetting takes place via the snap ring.

The output element 14 is designed as an output shaft, which has engagement features for transmitting the torque and thus engages positively with the drive body 24 in the direction of rotation. If the permissible torque M_{Z} is exceeded, the drive body 24 is rotated relative to the output element 14. This relative rotation is achieved by releasing the positive locking between the drive body 24 and the output element 14 against the preload exerted by the compression element 26. This process is known as over-latching.

FIG. 2a is a perspective view of the drive element 12, with a view of the connecting region 20. This is where the drive body 24 has output structures 28 which enable a torque-transmitting coupling to the output element 14 in the compressed state. Since the drive body 24 is made from a viscoelastic plastic material, it is of sufficient strength to transmit the torque.

The connecting region 20 of the drive body 14 is slotted, thus forming two semi-hollow cylindrical spring tabs 30a, 30b. The latter are movable in the radial direction R, in particular resiliently. This allows the spring tabs 30a, 30b to be spaced from one another, which makes it possible to overcome the positive fit or the positive/non-positive fit between the output element 14 and the output structures 28.

The drive body 24, which is essentially cylindrical in its outer design, has a circumferential groove in the area of the two spring tabs 30a, 30b, which groove accommodates a compression element 26 designed in the form of a snap ring, in particular made from spring steel.

This compression element 26 is essentially used to set the radial force counteracting the widening and thus the permissible torque M_{Z}.

Because the compression element 26 is not made of a viscoelastic material, its spring behavior will not change at all or only insignificantly over a long period of time. This means that the permissible torque can still be transmitted within narrow limits over a long period of time, even though the drive body 24 is made from a viscoelastic material, in particular from a linear viscoelastic material. As a result, the drive body can be produced in a space-saving and cost- effective manner in a primary shaping process, for example in an injection molding process.

FIG. 2b is a perspective view of the drive element 12, with a view of the drive region 18. The drive region 18 has a drive contour 32, which is designed in the form of a tool engagement portion in the form of an internal drive, so that rotary motion imparted with a corresponding tool, in particular a screwdriver, can be transferred to the drive element 12.

If the applied torque is less than the permissible torque M_{Z}, the rotary motion will be transmitted to the output element 14. If the applied torque is higher than it, this will cause the drive element 12 to over-latch, and the drive element 12 will rotate relative to the output element 14 to the next latching position.

FIG. 3 is a cross-sectional view III-III of the drive element 12 and of the output element 14 of the transmission device 10 according to the invention in the transmission position as shown in FIG. 1. The drive element 12 has two spring tabs 30a, 30b, which are pressed against the output element 14 via the compression element 26 which is designed as a snap ring. The output structures 28 ensure positive engagement. Both the contour of the output element 14 and the output structures 28 are of a rounded design. This allows largely wear-free over-latching.

FIG. 4a is the side view of a drive element 12 and output element 14 in a position in which the drive torque exceeds the permissible torque. The spring tabs 30a, 30b of the drive body 24 are bent outwards against the preload of the compression element 26. As it continues to rotate, the drive body 24, with its output structures 28, then slides further by one recess in the output element 14, after which the compression element 26 and the drive body 24 return to their initial position in the radial direction.

FIG. 4b is a view of the cross-section of FIG. 4a. As seen here, the rounded corners are in contact with the rounded drive structures 28, meaning that the drive body 24 is widened maximally in its connecting region 20.

After the over-latching has taken place, the drive body 24 with its drive structures 28 then settles back into the recesses of the output element 14.

In this way, an easy and reliable transmission device is provided which, even after a long period of time, still enables the transmission of a torque that is kept within narrow limits.

1-7. (canceled)

8. A transmission device (10), comprising
an output element (14), and
a drive element (12), wherein the drive element (12) comprises a drive body (24) made from a first material, and the drive body (24) comprises a drive region (18) and a connecting region (20),
wherein the output element (14) engages into the connecting region (20),
the connecting region (20) comprises positively locking structures (28) that are designed to transmit a torque to the output element (14),
the connecting region (20) is configured in such a way that the positively locking structures (28) are radially movable, with the result that the output element (14) is rotatable relative to the drive body with widening of the connecting region (20),
wherein the drive element (12) comprises a compression element (26) that preloads the drive body (24) inwards in the radial direction in the connecting region (20),
the compression element (26) is formed from a second material that is different from the first material and is elastic in the region of the widening portion, and
the compression element has a higher spring stiffness than the connecting region of the drive body.

9. The transmission device according to claim 8, wherein the second material of the compression element (26) is a material whose stress-strain curve changes less over temperature, over time, or over both temperature and time, than the stress-strain curve of the first material.

10. The transmission device according to claim 8, wherein the connecting region (20) and the drive region (18) are arranged successively in the axial direction, with the connecting region (20) having at least two substantially hollow-cylindrical tab portions (30a, 30b), each of which has at least one positively locking structure (28).

11. The transmission device according to claim 9, wherein the connecting region (20) and the drive region (18) are arranged successively in the axial direction, with the connecting region (20) having at least two substantially hollow-cylindrical tab portions (30a, 30b), each of which has at least one positively locking structure (28).

12. The transmission device according to claim 8, wherein the drive body (24) comprises a cylindrical basic shape and a groove on its outer circumferential surface in the connecting region (20), and the groove accommodates a ring-shaped compression element (26).

13. The transmission device according to claim 10, wherein the positively locking structure (28) is formed by at least one longitudinal groove-like indentation in the material of a tab portion (30a, 30b).

14. The transmission device according to claim 11, wherein the positively locking structure (28) is formed by at least one longitudinal groove-like indentation in the material of a tab portion (30a, 30b).

15. The transmission device according to claim 8, wherein the compression element (26) is made from spring steel.

16. The transmission device according to claim 8, wherein the drive body (24) is rotatably mounted on its outer circumference in its drive region (18) and has tool engagement features on its end face, in particular an internal drive.
